(19) United States
(12) Patent Application Publication
(10) Pub. No.: US 2026/0170478 A1
(43) Pub. Date: Jun. 18, 2026

(54) SPLITTING TRANSACTIONS FOR VARIABLE GROUPS

(71) Applicant: American Express Travel Related Services Company, Inc., New York, NY (US)

(72) Inventors: Jaime Berkowitz, Hoboken, NJ (US); Ian T. Moritz, Brooklyn, NY (US); Ian P. Pulice, Venice, CA (US); Rami Omar Abulaban, Manhattan, NY (US); Timothy Sweeny, Somers, NY (US)

(21) Appl. No.: 18/981,379

(22) Filed: Dec. 13, 2024

(51) Int. Cl. G06Q 20/22; G06Q 20/32

(52) U.S. Cl. CPC G06Q 20/22; G06Q 20/3223

(57) ABSTRACT

Disclosed are various embodiments for a system which splits transactions among variable groups. A computing device can receive a split request to split a transaction cost associated with a transaction. The computing device can receive a selection of a plurality of contributors, the selection including user identifiers corresponding to the contributors. Next, the computing device can send a contribution request to client devices, each client device corresponding to a user identifier. The computing device can receive a number of contribution responses from a corresponding number of client devices, each contribution response identifying an amount to contribute to the transaction cost. Then, the computing device can process the transaction based at least in part on the number of contribution responses.

### BACKGROUND

In many circumstances, multiple people may wish to pay or contribute to a single transaction. However, most payment platforms are not configured to allow multiple parties to initiate a single transaction. Accordingly, a single user may be forced to initiate the transaction for a group of individuals and then manually distribute the cost downstream.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-7 are pictorial diagrams of example user interfaces rendered by a client device during a primary user's experience according to various embodiments of the present disclosure.

FIGS. 8-10 are pictorial diagrams of example user interfaces rendered by a client device during a secondary user's experience according to various embodiments of the present disclosure.

FIG. 11 is a drawing of a network environment according to various embodiments of the present disclosure.

FIGS. 12 and 13 are flowcharts illustrating examples of functionality implemented as portions of an application executed in a computing environment in the network environment of FIG. 11 according to various embodiments of the present disclosure.

FIG. 14 is a sequence diagram illustrating one example of communications in the network environment of FIG. 11 according to various embodiments of the present disclosure.

### DETAILED DESCRIPTION

Disclosed are various approaches for splitting transactions for variable groups. When a user makes a transaction with a transaction account, such as a charge card, credit card, or debit card, there are often circumstances where they wish to split a charge among multiple individuals. For example, a user may wish to split the charge for a group dinner, a group gift, or a group trip with the participants of the dinner, gift, or trip. In addition, there can be numerous circumstances where the number of individuals who will split the charge is unknown or variable. For example, a primary user could rent a vacation home with the capability to host multiple guests and invite multiple friends after the booking. This user may wish to split the charge for the rental with only those friends who can attend the trip. The user may be waiting on responses from friends who may or may not be available while the charge is processed to the user. Thus, waiting for responses from participants in the transaction may result in the primary user suffering several inconveniences due to a charge limiting their total available credit, generating interest while awaiting payment, or other inconveniences from being unable to spread the cost.

To solve the difficulties mentioned above, embodiments of the present disclosure can receive a selection of a transaction to split as well as a selection of a group of potential contributors. The embodiments can generate a contribution request template to send to each of the group of potential contributors. Once they have received the contribution request, the potential contributors can respond positively (e.g., that they would like to participate in the transaction) or negatively (e.g., that they would not like to participate in the transaction). A nonresponsive potential contributor can be treated the same as a negative response. The embodiments can receive a number of positive contribution responses and split the selected transaction among the contributors who sent the positive contribution responses. Depending on the parameters set by the user originating the transaction, as well as potential limits included with contribution responses, the transaction can be split among contributors evenly or according to a pledged sum or percentage.

The embodiments described herein provide certain improvements from prior approaches in the field of mobile payments. This disclosure provides for an improved user experience by making a complicated transaction workflow with an unknown number of participants easier and quicker to complete. For example, the user does not have to designate split amounts for each contributor before they know a total number of contributors. In addition, the user does not have to draft and send multiple separate requests to the various potential contributors, but rather has one simplified interaction to send multiple requests at one time.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

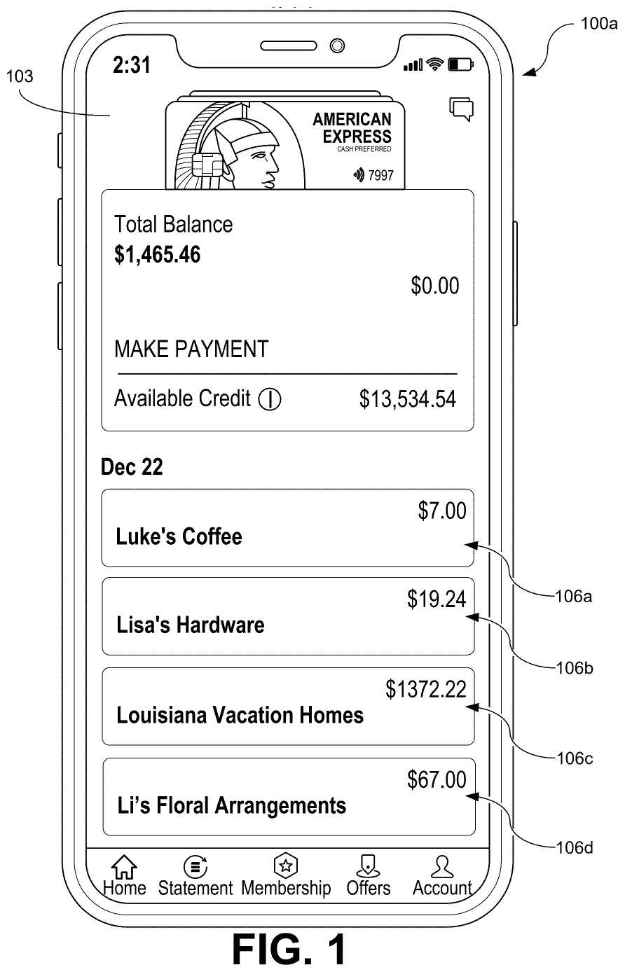

FIG. 1 depicts a client device 100a of a primary user displaying a user interface 103 according to various embodiments of the present disclosure. The user interface 103 can show information related to the transaction account of a user. This information can include details such as a total balance associated with the transaction account as well as a list of one or more transactions that the user has made with their transaction account. Further details about individual transactions can also be presented, such as the date of the transaction, the amount of the transaction, and the counterparty for the transaction (e.g., the merchant, service provider, etc.). The user interface 103 can further include one or more user interface elements 106 (e.g., user interface element 106a, 106b, 106c, 106d, etc.) with which the user can interact. For example, a user can select a user interface element 106 via touch, click, or other interaction. The selection of a user interface element 106 can direct the user to another user interface 103. In the example of FIG. 1, a user can interact with a user interface element 106 to view or obtain more information about an individual transaction.

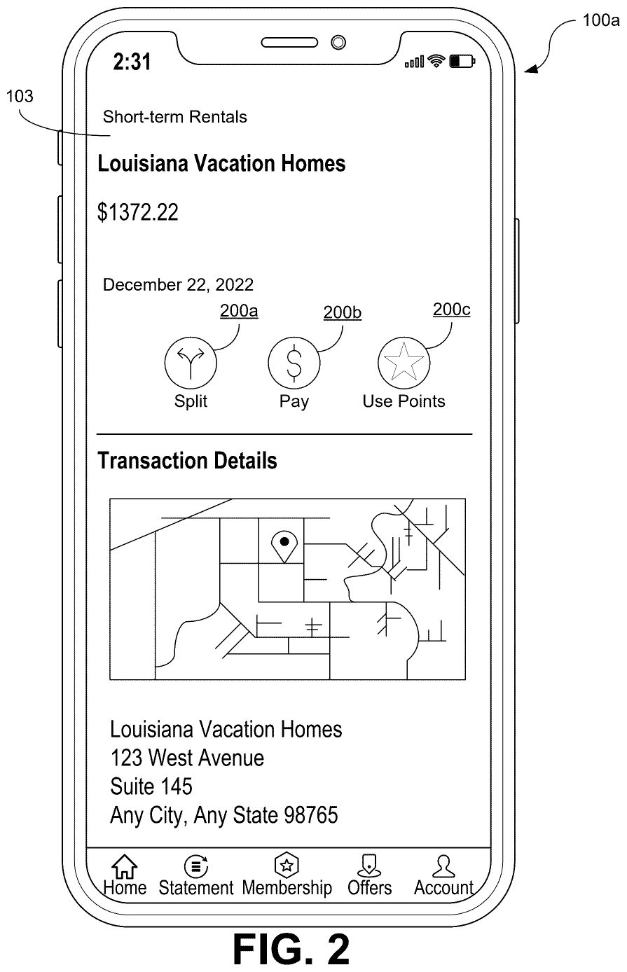

Next, FIG. 2 depicts a user interface 103 presented by the client device 100a of a primary user according to various embodiments of the present disclosure. A user can select one of the user interface elements 106 (e.g., user interface element 106c) from FIG. 1 to reach the user interface 103 depicted in FIG. 2. The user interface 103 in FIG. 2 presents the user with additional information and details about a transaction selected from the previous page. The user interface 103 can present information to the user such as the type of transaction, the type of merchant, the amount of the transaction, the date of the transaction, and the location of the transaction or merchant. In addition, the user interface can include one or more user interface elements 200 (e.g., 200a, 200b, 200c, etc.) to allow the user to perform various actions related to the transaction. For example, a user could interact with user interface element 200a to split the cost of the transaction with one or more individuals, while the user could interact with user interface element 200b to pay for the transaction (e.g., by transferring funds from checking or savings account) or interact with user interface element 200c to redeem rewards points to pay for the transaction.

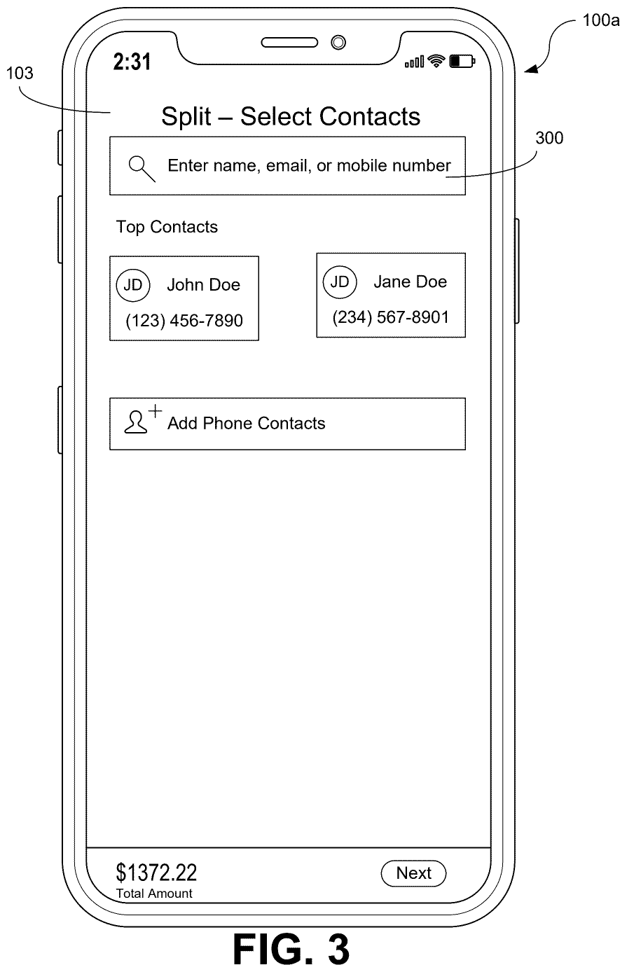

Moving to FIG. 3, shown is another example of a user interface 103 depicted on the client device 100a of the primary user according to various embodiments of the present invention. A user can select one of the user interface elements 200 (e.g., user interface element 200a) from FIG. 2 in order to reach the user interface 103 of FIG. 3. The user interface 103 of FIG. 3 can show various options for how to split a transaction with a group of secondary users. For example, the user interface 103 can show the transaction to be split as well as a list contacts to select as participants in the split. The contacts can be presented as the user's most commonly selected contacts, contacts who are associated with the transaction through other channels or platforms (e.g., reservation platforms, etc.), or contacts who were known to be near the location of the transaction during the time the transaction was made. The user can select a group of contacts from the recommended contacts and/or from a separate list of contacts, as well as search for contacts through user interface element 300.

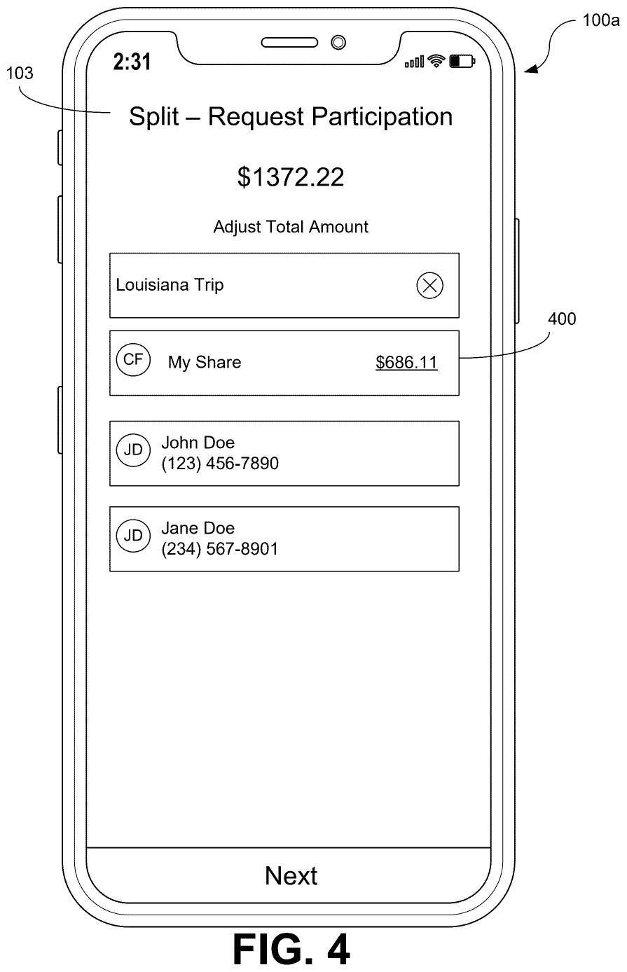

FIG. 4 shows another example of a user interface 103 depicted on the client device 100a of the primary user according to various embodiments of the present invention. After the primary user (e.g., originator or originating user) has selected a group of contacts to participate in the split transaction, the primary user can be presented with the list of selected contacts, the transaction details, and other details regarding the split. For example, the user can interact with user interface element 400 to specify a contribution that they would like to make toward the transaction total. While not necessary, if the primary user chooses to specify their share of the split, they may do so before sending the split request to their selected contacts. In some examples, the user can enter an amount to contribute to the transaction. In some examples, the user can enter a specific percentage that they wish to contribute to the transaction.

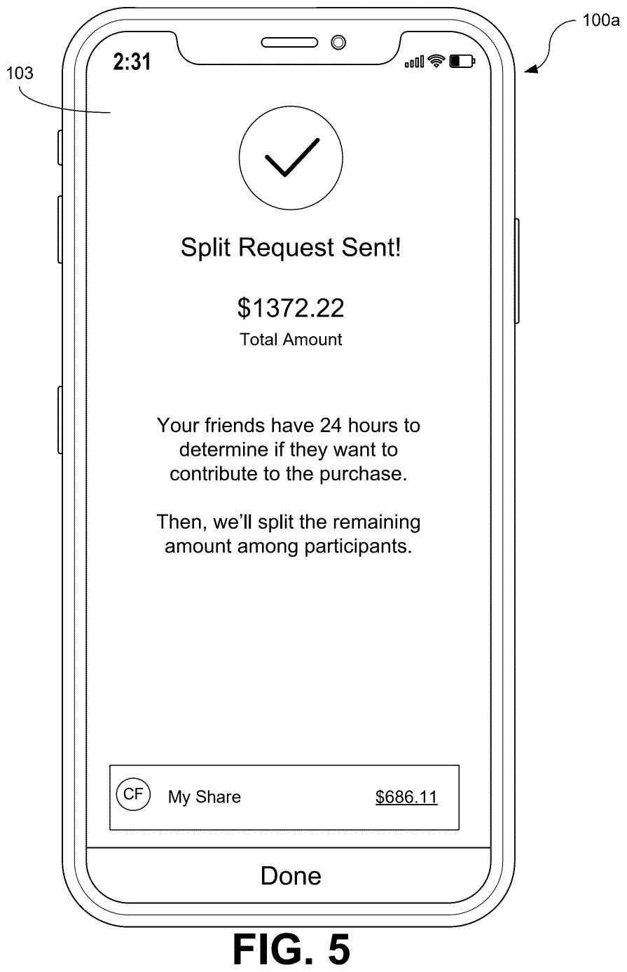

In FIG. 5, another example of a user interface 103 is shown on a client device 100a of the primary user according to various embodiments of the present invention. The user interface 103 can depict a notification or message to the user informing them that split requests have been sent to each of the selected contacts from the user interface 103 in FIG. 3. The user interface of FIG. 5 can appear once the primary user has initiated the split request, and each request has been sent to the respective contact. In some examples, the notification or message can include information about the request, such as the total amount of the transaction being split, the contacts who received split requests, a specified share of the originating user, etc.

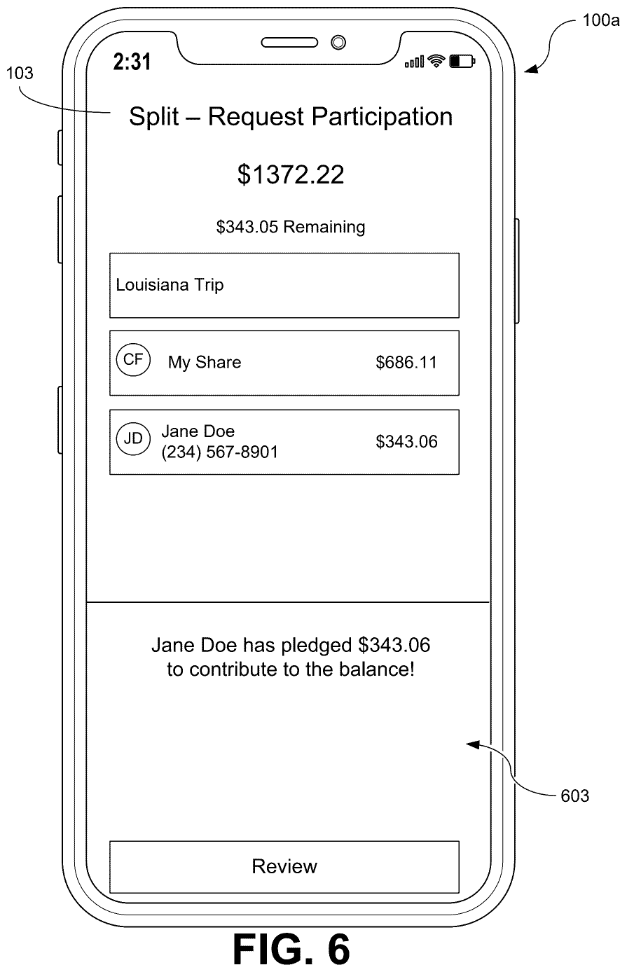

Next, at FIG. 6, shown is another example of a user interface 103 on a client device 100a of the primary user according to various embodiments of the present invention. The user interface 103 can depict a live view of the participation of various contacts who received the split request. For example, as each contact responds with whether or not they will contribute, the user interface 103 of FIG. 6 can be updated to reflect the contribution responses. In some examples, where a contributor responds with a specified amount or percentage for their contribution, the user interface 103 of FIG. 6 can display this information as well. In addition to showing information regarding contribution responses, the user interface 103 of FIG. 6 can include information regarding the transaction being split, such as total amount, name of the transaction, an amount remaining to be split, as well as other information.

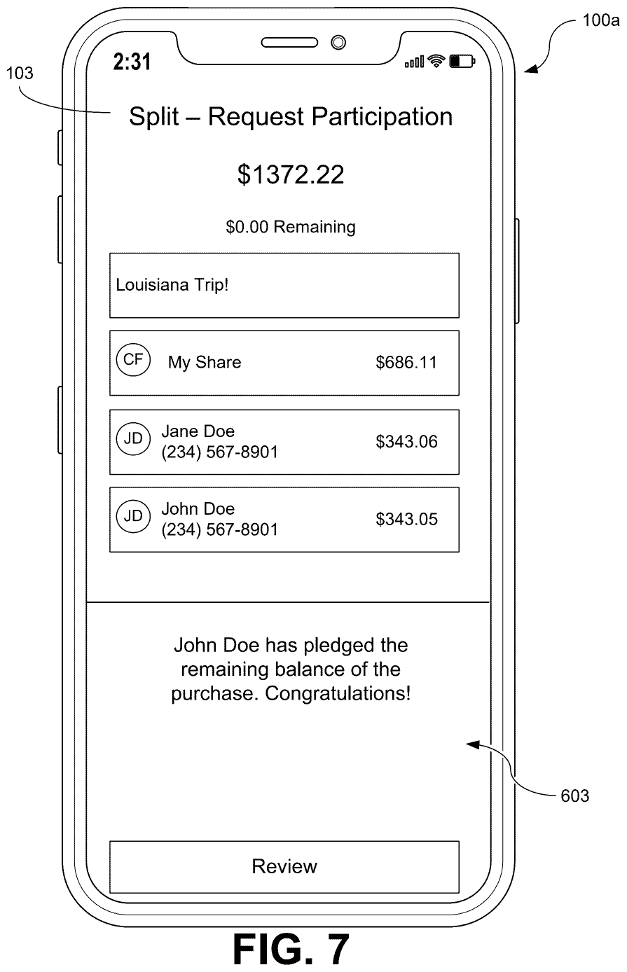

At FIG. 7, shown is another example of a user interface 103 on a client device 100a of the primary user according to various embodiments of the present invention. Similarly to FIG. 6, the user interface 103 can depict a live view of the participation of various contacts who received the split request. However, the user interface 103 of FIG. 7 shows the last contribution response along with a message notifying the user that the full transaction has been split. This additional notification or message can be triggered by a number of contributors pledging amounts which add up to the total amount of the transaction, by the expiration of a live time for the split request, or by some other event.

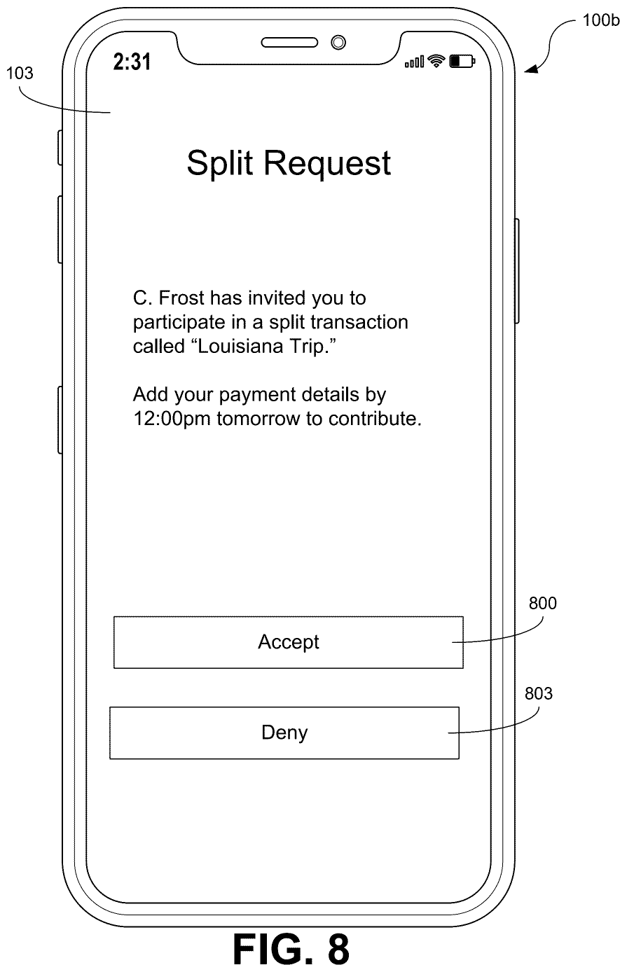

Moving to FIG. 8, shown is an example of a user interface 103 on a client device 100b of a secondary user according to various embodiments of the present invention. The secondary user can be the recipient of a split request (e.g., contribution request) sent from an originating user (e.g., originator or primary user). The user interface 103 of FIG. 8 can be configured to display a notification or message when the secondary user receives a split request. In some examples, the message on the user interface 103 can include details about the request, such as the name or identity of the originator, the name of the transaction, the total amount of the transaction, a requested amount of the transaction, a live time of the split request, etc. The notification or message can be triggered by receipt of a split request. In some examples, the user interface 103 of FIG. 8 can include a user interface element 800 to allow the user to accept the split request. The user interface 103 of FIG. 8 can also include a user interface element 803 to allow the user to deny the split request.

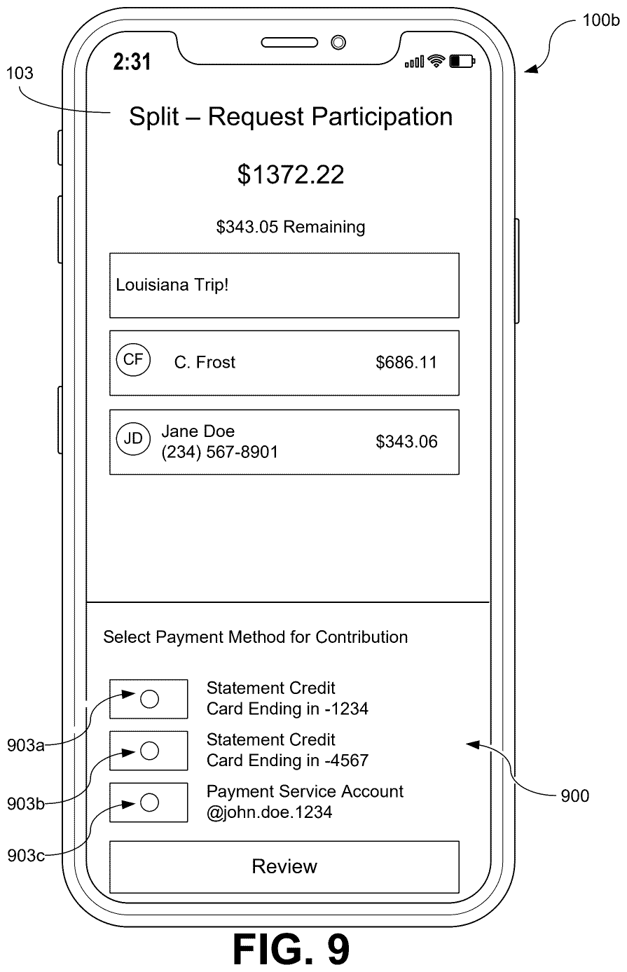

At FIG. 9, shown is another example of a user interface 103 on a client device 100b of a secondary user according to various embodiments of the present invention. The user interface 103 of FIG. 9 can be reached by the user interacting with user interface element 800 from the user interface 103 of FIG. 8. Once the user has accepted the split request, the user can be directed to the user interface 103 of FIG. 9 to see more information regarding the split request. For example, the user interface 103 can include information about the split request such as the total amount of the transaction, the name of the transaction, other contributors who have accepted the request and, in some examples, the amounts that have been contributed. Further, the user interface 103 can include payment options 900 for the user to select which payment method will be used to contribute to the transaction. In some examples, the payment options 900 can include transaction accounts, payment service accounts, digital wallets, or other payment instruments. The user can select a payment option 900 by interacting with a user interface element 903 (e.g., 903a, 903b, 903c, etc.).

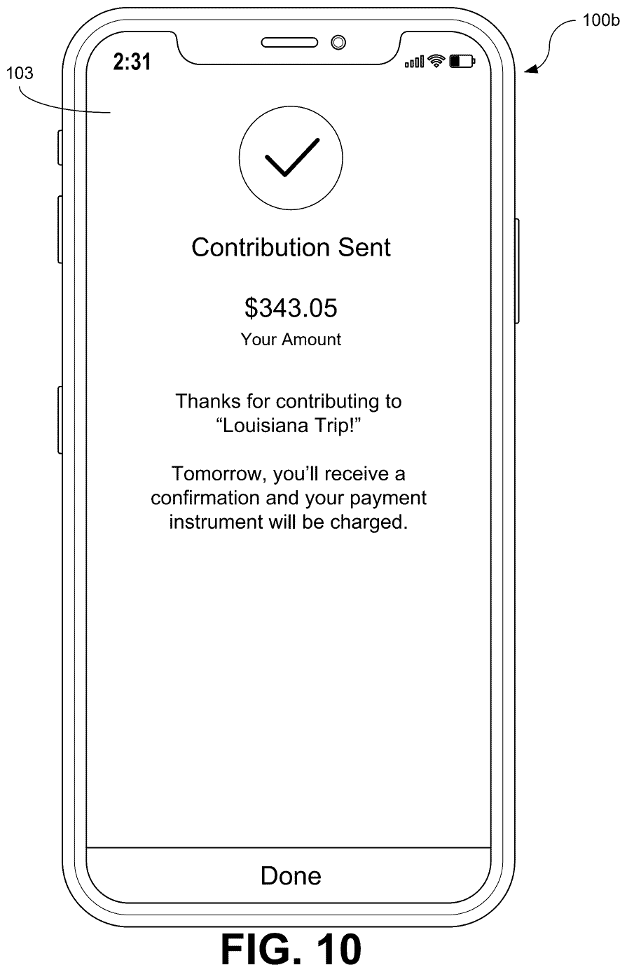

Next, in FIG. 10, shown is another example of a user interface 103 on a client device 100b of a secondary user according to various embodiments of the present invention. The user can reach the user interface 103 of FIG. 10 by interacting with a user interface element 903 from FIG. 9 to select a payment option 900. Once the payment information has been collected, the user can be directed to the user interface 103 of FIG. 10. The user interface 103 of FIG. 10 can display a notification or message informing the user that their contribution has been sent. In some examples, the notification or message can include information about the contribution, such as a total amount or percentage of the contribution, the name of the transaction being split, as well as information about when the charge will be processed. Further, the notification or message can include other information or options, such as an option to modify the contribution or a countdown to the time the split request expires.

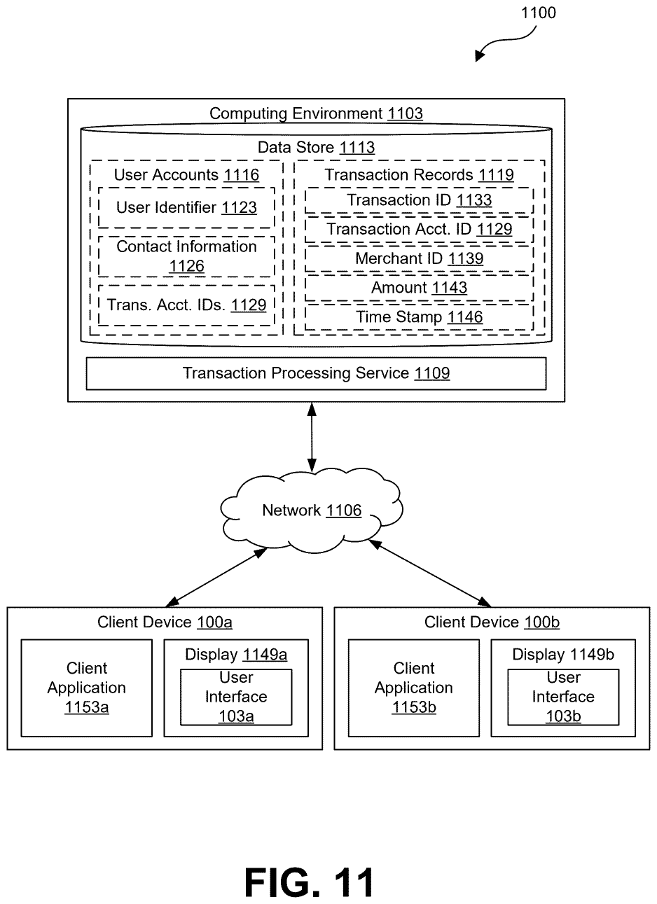

With reference to FIG. 11, shown is a network environment 1100 according to various embodiments. The network environment 1100 can include a computing environment 1103 and one or more client devices 100 (e.g., 100a, 100b, etc.), which can be in data communication with each other via a network 1106.

The network 1106 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 1106 can also include a combination of two or more networks 1106. Examples of networks 1106 can include the Internet, intranets, extranets, virtual private networks (VPNs), and similar networks.

The computing environment 1103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 1103 can employ a plurality of computing devices that can be arranged in one or more server banks or computer banks or other arrangements. Such computing devices can be located in a single installation or can be distributed among many different geographical locations. For example, the computing environment 1103 can include a plurality of computing devices that together can include a hosted computing resource, a grid computing resource or any other distributed computing arrangement. In some cases, the computing environment 1103 can correspond to an elastic computing resource where the allotted capacity of processing, network, storage, or other computing-related resources can vary over time.

Various applications or other functionality can be executed in the computing environment 1103. The components executed on the computing environment 1103 include a transaction processing service 1109, and other applications, services, processes, systems, engines, or functionality not discussed in detail herein.

The transaction processing service 1109 can be executed to split a transaction among members of a variable group. The transaction processing service 1109 can receive a request to split a transaction from an originating user as well as a list of potential contributors selected by the originating user. The transaction processing service 1109 can send split requests or contribution requests to each of the identified potential contributors. By limiting a time for replies and collecting responses from the potential contributors withing that time, the transaction processing service 1109 can determine a final number of contributors for the split and divide the transaction among the contributors. In some examples, the transaction processing service 1109 can charge each contributor and the originator an equal amount, based at least in part on the number of contributors. However, in other examples, the transaction processing service 1109 can charge each contributor and the originator an amount based at least in part on an amount specified by the contributor. In addition to these functions, the transaction processing service 1109 can send a number of notifications, alerts, or messages to the originator and to the contributors to notify the users of various steps of the process.

Also, various data is stored in a data store 1113 that is accessible to the computing environment 1103. The data store 1113 can be representative of a plurality of data stores 1113, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 1113 is associated with the operation of the various applications or functional entities described below. This data can include one or more user accounts 1116, one or more transaction records 1119, and potentially other data.

A user account 1116 can represent information related to a user who has at least one transaction account (e.g., credit or charge card account, demand deposit account, stored value payment account, etc.) maintained by the issuer who operates the transaction processing service 1109. Accordingly, each user account 1116 can include information such as a user identifier 1123, contact information 1126, and one or more transaction account identifiers 1129. The user identifier 1123 for a user account 1116 can represent any identifier that uniquely identifies one user account 1116 with respect to another user account 1116. The contact information 1126 can represent identifiers that can be used to send information to the user, such as telephone numbers (e.g., cellular phone numbers), email addresses, mailing addresses, etc. The transaction account identifiers 1129 can represent identifiers that uniquely identify one transaction account with respect to another transaction account. The transaction account identifiers 1129 can be stored in association with a user account 1116 and can represent those transaction accounts that a user owns, controls, or is an authorized user.

A transaction record 1119 can represent any transaction made with a transaction account (e.g., credit or charge card account, demand deposit account, stored value payment account, etc.). Accordingly, each transaction record 1119 can include information such as a transaction identifier 1133, a transaction account identifier 1129 of the transaction account that was used for the transaction, a merchant identifier 1139 for the merchant with whom the transaction was made, the amount 1143 of the transaction, and the time stamp 1146 of the transaction. The transaction identifier 1133 can represent any identifier that uniquely identifies one transaction with respect to another and, therefore, one transaction record 1119 with respect to another. The merchant identifier 1139 can represent any identifier that uniquely identifies one merchant with respect to another merchant. In some examples, the merchant identifier 1139 can further identify the type of merchant (e.g., service provider, merchant of goods, etc.). The amount 1143 can represent the amount of currency or currency equivalent (e.g., rewards points), or combination thereof, used to pay for or fund the transaction. The time stamp 1146 can represent the date and/or time at which the transaction was authorized or that a request to authorize the transaction was made, depending on the implementation.

The client device 100 (e.g., 100a, 100b, etc.) is representative of a plurality of client devices that can be coupled to the network 1106. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 can include one or more displays 1149 (e.g., 1149a, 1149b, etc.), such as liquid crystal displays (LCDs), gas plasma-based flat panel displays, organic light emitting diode (OLED) displays, electrophoretic ink (“E-ink”) displays, projectors, or other types of display devices. In some instances, the display 1149 can be a component of the client device 100 or can be connected to the client device 100 through a wired or wireless connection.

The client device 100 can be configured to execute various applications such as a client application 1153 (e.g., 1153a, 1153b, etc.) or other applications. The client application 1153 can be executed in a client device 100 to access network content served up by the computing environment 1103, or other servers, thereby rendering a user interface 103 on the display 1149. To this end, the client application 1153 can include a browser, a dedicated application, or other executable, and the user interface 103 can include a network page, an application screen, or other user mechanism for obtaining user input. The client device 100 can be configured to execute applications beyond the client application 1153 such as email applications, social networking applications, word processors, spreadsheets, or other applications.

Next, a general description of the operation of the various components of the network environment 1100 is provided. More detailed descriptions of the operations of individual components are discussed with respect to the subsequent flowcharts.

To begin, a primary user can use their client device 100a to initiate a split transaction. For example, the primary user can choose a transaction record 1119 to split among a group of contributors. Then, the primary user can select one or more contacts to serve as potential contributors for the selected transaction record 1119. In some examples, the client application 1153a on the primary user's client device 100a can send the selection of the transaction record 1119 and user identifiers 1123 for the potential contributors to the transaction processing service 1109. In some examples, the transaction processing service 1109 can use the user accounts 1116 to determine client devices 100b corresponding to the respective potential contributors. The transaction processing service 1109 can share a contribution request (e.g., split request) with the client devices 100b of the potential contributors.

A secondary user, who has been selected as a potential contributor, can receive the contribution request via their client device 100b. The secondary user can choose whether to participate in the split transaction or not. When the secondary user chooses to participate in the split transaction, the client device 100b of the secondary user can inform the transaction processing service 1109 by sending a contribution response. The transaction processing service 1109 can continue to receive contribution responses from the potential contributors until a time for the split request has expired, until a threshold of contributors has been met, or until some other condition is met. In some examples, the transaction processing service 1109 can send an alert or notification to potential contributors who have not responded to warn them of an upcoming expiration of the split request. The transaction processing service 1109 can also send an alert or notification to the potential contributors who have not responded to notify them that the split request has already expired.

After receiving a number of contribution responses, the transaction processing service 1109 can be executed to split an amount 1143 of the transaction record 1119 among those contributors who responded positively to the split request and with the originator. By waiting until contribution responses have been received and confirmed, the transaction processing service 1109 can divide the amount 1143 of the transaction record 1119 evenly across participants or can split the amount 1143 based at least in part on specified contributions from the contributors.

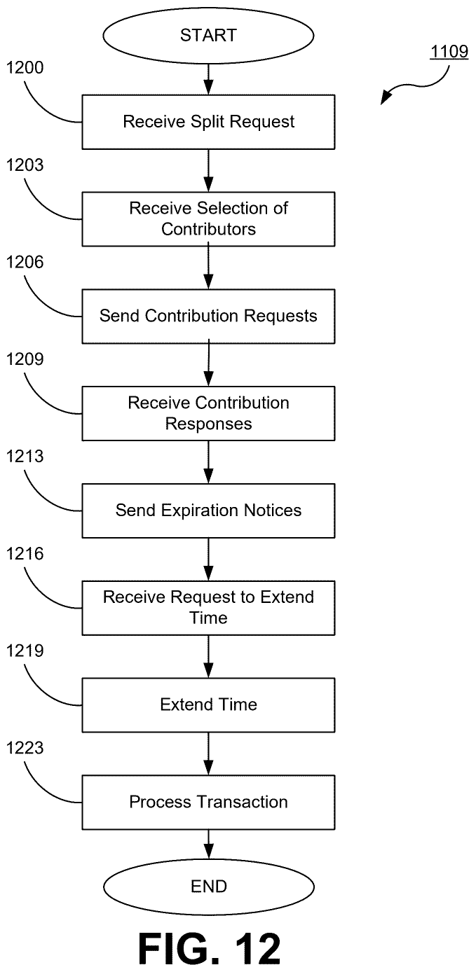

Referring next to FIG. 12, shown is a flowchart that provides one example of the operation of a portion of the transaction processing service 1109. The flowchart of FIG. 12 provides merely an example of the many different types of functional arrangements that can be employed to implement the operation of the depicted portion of the transaction processing service 1109. As an alternative, the flowchart of FIG. 12 can be viewed as depicting an example of elements of a method implemented within the network environment 1100.

Beginning with block 1200, the transaction processing service 1109 can be executed to receive a split request. The split request can include information such as a transaction record 1119 to be split, a user identifier 1123 for the originating user, an amount 1143 of the transaction to be split, a time during which the split request is active (e.g., live time), etc. The transaction processing service 1109 can receive a split request from a client application 1153a on a client device 100a. In some examples, the transaction processing service 1109 can receive the split request in response to having sent a prompt to split the transaction to the client application 1153a.

Next, at block 1203, the transaction processing service 1109 can be executed to receive a selection of contributors. The selection of contributors can represent a list of one or more contacts of the primary user who have been selected by the primary user to contribute to the transaction. In some examples, the selection of contributors can include user identifiers 1123 corresponding to the contributors. The transaction processing service 1109 can receive the selection of contributors from a client application 1153a on the client device 100a of the primary user. In some examples, the transaction processing service 1109 receives the selection of contributors as a part of the split request from block 1200.

At block 1206, the transaction processing service 1109 can be executed to send contribution requests. A contribution request can comprise a message, notification, or alert which can be sent to a secondary user (e.g., contributor) to inform them that the primary user (e.g., originator) has invited them to contribute to a transaction. The contribution request can include the transaction record 1119 to be split, an amount 1143 to be split, a user identifier 1123 for the originator, as well as other information relevant to the secondary user. In some examples, the transaction processing service 1109 generates a unique contribution request for each contributor of the selection of contributors from block 1203. The transaction processing service 1109 can send a contribution request to each contributor of the selection of contributors from block 1203. In some examples, the transaction processing service 1109 sends the contribution requests to client applications 1153b on client devices 100b of the contributors.

Next, at block 1209, the transaction processing service 1109 can be executed to receive contribution responses. A contribution response can be a positive response (e.g., that a secondary user will contribute funds to the transaction), a negative response (e.g., that a secondary user will not contribute funds), or no response. When no contribution response is received, the transaction processing service 1109 can treat the no response as a negative response. The transaction processing service 1109 can receive the contribution responses based at least in part on sending the contribution requests at block 1206. In some examples, the transaction processing service 1109 receives one or more contribution responses from the contributors to whom the contribution requests were sent.

At block 1213, the transaction processing service 1109 can be executed to send expiration notices. An expiration notice can represent a notification, message, or alert which informs a user that a live time of the split request is expiring soon or in some examples, has expired. In some examples, an expiration notice can include an option for a user to respond and request more time. The transaction processing service 1109 can send one or more expiration notices to client applications 1153b of contributors to alert them that a time to respond is closing or has closed. In some examples, the transaction processing service 1109 can send an expiration notice to the client application 1153a of the originator to inform them that a time for receiving responses is closing or has closed.

At block 1216, the transaction processing service 1109 can be executed to receive a request to extend time. In some examples, the transaction processing service 1109 can receive a request to extend a live time of the split request from one or more client applications 1153 (e.g., 1153a, 1153b). The transaction processing service 1109 can receive a request to extend a live time based at least in part on having sent the expiration notices at block 1213. In some examples, where a request to extend time has been received from a client application 1153b of a contributor, the transaction processing service 1109 can forward the request to a client application 1153a of the originator for approval.

Next, at block 1219, the transaction processing service 1109 can be executed to extend time. The transaction processing service 1109 can extend the live time of a split request. In some examples, the transaction processing service 1109 can extend the time a request is live based at least in part on receiving a request to extend time from block 1216. The transaction processing service 1109 can extend time automatically in response to receiving a request to extend, or in some examples, the transaction processing service 1109 can extend the time based at least in part on receiving an approval of a request to extend time. The transaction processing service 1109 can extend the time by a specified amount or by a default amount. Once the time is extended, the transaction processing service 1109 can repeat the process in blocks 1209 to 1219.

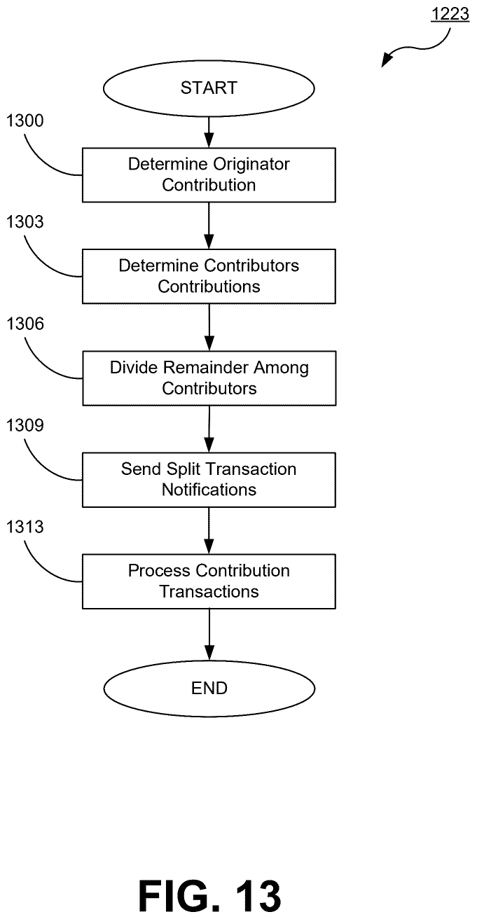

At block 1223, the transaction processing service 1109 can be executed to process the transaction. The transaction processing service 1109 can determine the final number of contributors and their respective user accounts 1116 based at least in part on the contribution responses received at block 1209. In some examples, the transaction processing service 1109 can cause each of the user accounts 1116 to be charged based at least in part on the total number of positive contribution responses received at block 1209. Further description of block 1223 can be found in the discussion of FIG. 13. After block 1223, the flowchart of FIG. 12 can end.

Referring next to FIG. 13, shown is a flowchart that provides one example of the operation of a portion of the transaction processing service 1109. The flowchart of FIG. 13 provides merely an example of the many different types of functional arrangements that can be employed to implement the operation of the depicted portion of the transaction processing service 1109 from block 1223 of FIG. 12. As an alternative, the flowchart of FIG. 13 can be viewed as depicting an example of elements of a method implemented within the network environment 1100.

Beginning with block 1300, the transaction processing service 1109 can be executed to determine an originator contribution. In some examples, the originator of the split request from block 1200 in FIG. 12 can specify an amount or percentage of the total transaction cost which they would like to contribute. In some examples, this amount or percentage can be an upper limit or lower limit on what the originator wishes to contribute. The originator contribution can be included in the split request received at block 1200 in FIG. 12.

At block 1303, the transaction processing service 1109 can be executed to determine one or more contributions from one or more respective contributors. One or more contributors can specify a contribution limit (maximum or minimum) in the form of an amount or percentage. The transaction processing service 1109 can determine one or more contributors who have specified contributions based at least in part on the contribution responses received at block 1209 of FIG. 12.

At block 1306, the transaction processing service 1109 can be executed to divide a remainder among the contributors. The transaction processing service 1109 can use the originator's contribution determined at block 1300 and the contributors'contributions determined at block 1303 to calculate a remainder. The remainder can be an amount or percentage of the total transaction cost which needs to be split among the contributors. In some examples, the transaction processing service 1109 can calculate the remainder based at least in part on the split request at block 1200 from FIG. 12. Using the remainder, the transaction processing service 1109 can determine how the remainder should be split among the contributors. For example, if four people contributed, and two specified their contributions, the remainder can be split evenly between the two who did not specify a contribution. Similarly, if no contributors specified a contribution, the remainder can be split evenly among the contributors. In another example, if each contributor specified a contribution and the remainder is greater than zero, the transaction processing service 1109 can charge the remainder to the originator.

Next, at block 1309, the transaction processing service 1109 can be executed to send split transaction notifications. After the determining the amount each contributor should contribute, the transaction processing service 1109 can send a notification to each contributor and to the originator, informing them of the amount that they owe. In some examples, the split transaction notification identifies the amount owed by the contributor to whom the notification was sent. The transaction processing service 1109 can send the split transaction notifications to client devices 100b associated with the contributors.

At block 1313, the transaction processing service 1109 can be executed to process the contribution transactions. After the transaction processing service 1109 has determined how to divide the remainder among the contributors and determined any specified contributions, the transaction processing service 1109 can process each split transaction to the appropriate user account 1116 associated with the respective contributor. In some examples, the transaction processing service 1109 can cause each of the user accounts 1116 to be charged based at least in part on the amount determined in blocks 1300, 1303, and 1306. After block 1313, the flowchart of FIG. 13 can end.

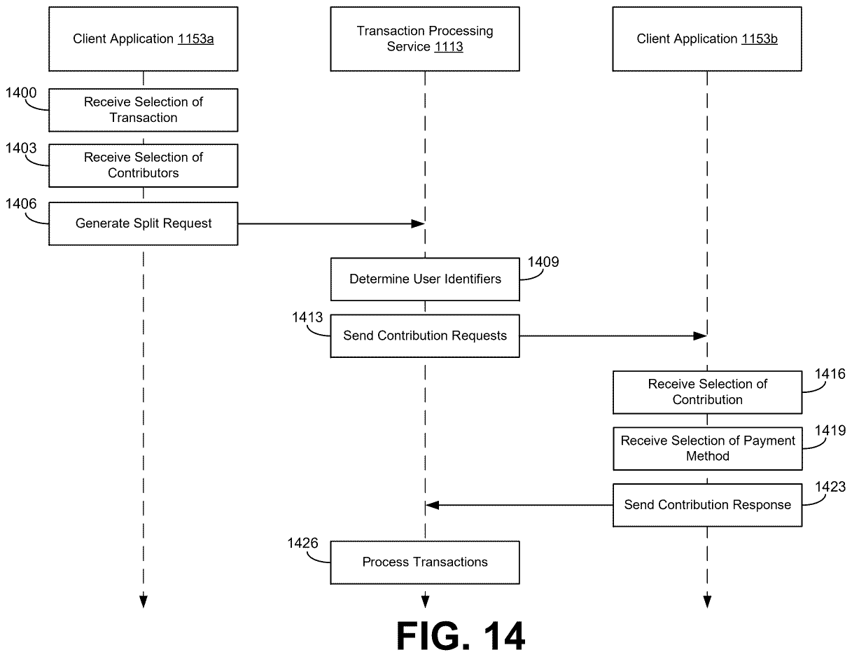

Referring next to FIG. 14, shown is a sequence diagram that provides one example of the operation of the interactions between the client applications 1153a and 1153b and the transaction processing service 1109. The sequence diagram of FIG. 14 provides merely an example of the many different types of functional arrangements that can be employed to implement the operations of the depicted portions of the client applications 1153a and 1153b and the transaction processing service 1109. As an alternative, the sequence diagram of FIG. 14 can be viewed as depicting an example of elements of a method implemented within the network environment 1100.

Beginning with block 1400, the client application 1153a of a primary user (e.g., originator) can be executed to receive a selection of a transaction. The client application 1153a can receive a selection of a transaction record 1119 through a user interface 103a. In some examples, the transaction record 1119 can be selected through a user interaction with a user interface element 106 from FIG. 1. However, other user interactions could also indicate a selection of a transaction record 1119.

At block 1403, the client application 1153a can be executed to receive a selection of contributors. Similarly to the selection of a transaction at block 1400, the client application 1153a can receive a selection of one or more contacts through a user interface 103a to serve as contributors. In some examples, the one or more contributors can be selected through a user interaction with a user interface element 300 from FIG. 3. However, other user interactions could also indicate a selection of one or more contributors.

Next, at block 1406, the client application 1153a can be executed to generate a split request. The split request can include information such as the transaction record 1119 selected at block 1400, the selection of contributors from block 1403, a user identifier 1123 associated with the originating user, and potentially other information. The client application 1153a can generate the split request in response to receiving the selection of the transaction at block 1400 and the selection of the contributors at block 1403. Once the split request has been generated, the client application 1153a can send the split request to the transaction processing service 1109.

At block 1409, the transaction processing service 1109 can be executed to determine user identifiers 1123. The transaction processing service 1109 can receive the split request from block 1406, and extract information from the split request. In some examples, the transaction processing service 1109 can extract information such as the transaction record 1119, the user identifier 1123 of the originator, and the user identifiers 1123 of the contributors. The transaction processing service 1109 can determine the user identifiers 1123 of the contributors based at least in part on the split request.

At block 1413, the transaction processing service 1109 can be executed to send contribution requests. In some examples, the transaction processing service 1109 identifies user accounts 1116 associated with the respective contributors based at least in part on the user identifiers 1123 determined at block 1409 and sends the contribution requests to the user accounts 1116. In some examples, using the user identifiers 1123 determined at block 1409, the transaction processing service 1109 can identify client devices 100b associated with the respective contributors and send the contribution requests to client applications 1153b on the client devices 110b.

Next, at block 1416, the client application 1153b of a secondary user (e.g., contributor) can be executed to receive a selection of a contribution. Once the client application 1153b has received a contribution request from the transaction processing service 1109 at block 1413, the client application 1153b can present the contribution request to the secondary user via a user interface 103b such as that of FIG. 8. The client application 1153b can receive a selection of a contribution (e.g., an acceptance of the contribution request, a specification of a contribution amount, etc.) through a user interaction with a user interface element 800. In some examples, the client application 1153b can receive a selection of a contribution through another user interaction.

At block 1419, the client application 1153b can be executed to receive a selection of a payment method. Once the client application 1153b receives an indication that the user would like to contribute, various payment options can be presented to the user through a user interface 103b. In some examples, the client application 1153b receives a selection of a payment method via a user interaction with a user interface element 903 in a user interface 103b such as that shown in FIG. 9. However, other user interactions could also indicate a selection of a payment method as well.

At block 1423, the client application 1153b can be executed to send a contribution response. Based at least in part on the selection of the contribution received at block 1416 and the selection of the payment method received at block 1419, the client application 1153b can generate a contribution response indicating the contribution selection from block 1416. The client application 1153b can send the contribution response to the transaction processing service 1109 in response to receiving the contribution request from block 1413. In some examples, the client application 1153b can send the contribution response to a client application 1153a of the originator.

Next, at block 1426, the transaction processing service 1109 can be executed to process the transactions. As described in FIGS. 11 and 12, the transaction processing service 1109 can process the transaction record 1119 based at least in part on the contribution responses received at block 1423. By identifying a total number of responses and determining any specified contributions from the originator and/or one or more of the contributors, the transaction processing service 1109 can divide the transaction amount according to the specified contributions and total number of contributors. Next, the transaction processing service 1109 can cause a user account 1116 of each contributor and the originator to be charged by the amount determined. After block 1426, the sequence diagram can end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 1103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
receive a split request from a user device, the split request representing a request to split a transaction cost associated with a transaction;
receive a selection of a plurality of contributors from the user device, the selection including a plurality of user identifiers corresponding to the plurality of contributors;
send a contribution request to each of a plurality of client devices, each client device of the plurality of client devices corresponding to a user identifier of the plurality of user identifiers;
receive a number of contribution responses from a corresponding number of client devices of the plurality of client devices, each contribution response identifying an amount to contribute to the transaction cost; and
process the transaction based at least in part on the number of contribution responses.

2. The system of claim 1, wherein the split request identifies a live time for the contribution request, the live time representing a time period in which the computing device can receive the number of contribution responses, and the machine-readable instructions further cause the computing device to at least process the transaction after the live time has expired.

3. The system of claim 2, wherein the machine-readable instructions further cause the computing device to at least extend the live time based at least in part on the number of contribution responses received.

4. The system of claim 1, wherein the split request identifies a specified contribution of an originator of the split request.

5. The system of claim 4, wherein the machine-readable instructions which, when executed, cause the computing device to process the transaction, further cause the computing device to at least:
subtract the specified contribution of the originator from the transaction cost to yield a remainder; and
divide the remainder among one or more contributors of the plurality of contributors based at least in part on the number of contribution responses.

6. The system of claim 1, wherein the machine-readable instructions which, when executed, cause the computing device to process the transaction, further cause the computing device to at least:
determine a number of contributors of the plurality of contributors based at least in part on the number of contribution responses;
identify a number of user identifiers corresponding to the number of contributors based at least in part on the number of contribution responses; and
divide the transaction cost among the number of contributors based at least in part on the number of user identifiers.

7. The system of claim 1, wherein at least one contribution response of the number of contribution responses identifies a specified contribution of a contributor.

8. A method, comprising:
receiving, by a computing device from a user device, a split request, the split request representing a request to split a transaction cost associated with a transaction;
receiving, by the computing device from the user device, a selection of a plurality of contributors, the selection including a plurality of user identifiers corresponding to the plurality of contributors;
sending, by the computing device, a contribution request to each of a plurality of client devices, each client device of the plurality of client devices corresponding to a user identifier of the plurality of user identifiers;
receiving, by the computing device, a number of contribution responses from a corresponding number of client devices of the plurality of client devices, each contribution response identifying an amount to contribute to the transaction cost; and
processing, by the computing device, the transaction based at least in part on the number of contribution responses.

9. The method of claim 8, wherein the split request identifies a live time for the contribution request, the live time representing a time period in which the computing device can receive the number of contribution responses, and further comprising processing, by the computing device, the transaction after the live time has expired.

10. The method of claim 9, further comprising extending, by the computing device, the live time based at least in part on the number of contribution responses received.

11. The method of claim 8, wherein the split request identifies a specified contribution of an originator of the split request.

12. The method of claim 11, wherein processing the transaction further comprises:
subtracting, by the computing device, the specified contribution of the originator from the transaction cost to yield a remainder; and
dividing, by the computing device, the remainder among one or more contributors of the plurality of contributors based at least in part on the number of contribution responses.

13. The method of claim 8, wherein processing the transaction further comprises:
determining, by the computing device, a number of contributors of the plurality of contributors based at least in part on the number of contribution responses;
identifying, by the computing device, a number of user identifiers corresponding to the number of contributors based at least in part on the number of contribution responses; and
dividing, by the computing device, the transaction cost among the number of contributors based at least in part on the number of user identifiers.

14. The method of claim 8, wherein at least one contribution response of the number of contribution responses identifies a specified contribution of a contributor.

15. A system, comprising:
a computing device comprising a processor and a memory; and
machine-readable instructions stored in the memory that, when executed by the processor, cause the computing device to at least:
receive a split request from a user device, the split request identifying a transaction and a number of user identifiers corresponding to a number of contributors for the transaction;
send a contribution request to a number of client devices associated with the number of user identifiers;
receive one or more contribution responses from one or more client devices of the number of client devices; and
split a transaction cost associated with the transaction among one or more contributors associated with the one or more contribution responses.

16. The system of claim 15, wherein the machine-readable instructions which, when executed, cause the computing device to split the transaction cost further cause the computing device to at least:
divide the transaction cost among the one or more contributors to create one or more contribution transactions; and
process the one or more contribution transactions.

17. The system of claim 15, wherein the machine-readable instructions, when executed by the processor, further cause the computing device to at least:
determine a time during which contribution responses can be received based at least in part on the split request;
determine one or more nonresponsive contributors of the number of contributors based at least in part on the one or more contribution responses; and
send an expiration notice to the one or more nonresponsive contributors.

18. The system of claim 17, wherein the machine-readable instructions, when executed by the processor, further cause the computing device to at least split the transaction cost after the time has expired.

19. The system of claim 17, wherein the machine-readable instructions, when executed by the processor further cause the computing device to at least:
receive a request to extend the time during which contribution responses can be received; and
send an extension notice to the one or more contributors.

20. The system of claim 15, wherein the machine-readable instructions further cause the computing device to at least send a split transaction notification to the one or more contributors associated with the one or more contribution responses, the split transaction notification identifying a split amount.
